(19) United States
(12) Patent Application Publication
(10) Pub. No.: US 2001/0003878 A1
(43) Pub. Date: Jun. 21, 2001

(54) Self-attaching banner and banner frame

(76) Inventor: Mark C. Dawkins, Lithonia, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/765,735

(22) Filed: Jan. 17, 2001

(51) Int. Cl. G09F 17/00

(52) U.S. Cl. 40/603

(57) ABSTRACT

A banner and frame system for displaying advertisements or messages (i.e., “Now Open”). The banner and frame system includes a modular banner frame and a frame support system. The modular banner frame includes a frame and a frame support system. The frame includes a plurality of frame sections and a plurality of frame connectors. The frame support system includes a plurality of support structures. The self-attaching banner includes a banner and an interlocking system. The interlocking system secures the self-attaching banner to the modular banner frame. The interlocking system includes a plurality of first fastener points and a plurality of second fastener points. The first fastener points and the second fastener points are positioned parallel to one another along the banner edges such that by folding the edge of the banner at a folding axis allows the first fastener points to interact with the second fastener points securely engaging one another. The self-attaching banner is secured to the banner frame using the interlocking system.

### TECHNICAL FIELD

The present invention is generally related to signage system and method and, more particularly, is related to an apparatus where a self-attaching banner is coupled to a modular banner frame.

### BACKGROUND OF THE INVENTION

Supermarkets, drugstores, gas stations and similar establishments use signage systems that often have various problems. The signage system generally consists of a banner or sign and a banner or sign frame of various dimensions. More specifically, signage systems include a flexible cloth or plastic banner, which typically convey company names, messages, prices, and special offers. The banners are mounted on support structures such as poles or frames. The problems associated with signage systems include banners that are prone to sag, tear, or become unattached, banner frames that are difficult to assemble and disassemble, and routinely are of only one size. Furthermore, these problems are the result of the necessity to display widely diverse consumer-related products, which do not lend themselves to the use of a single signage system.

Generally it is desired that unskilled employees be able to construct the banner frame and mount and change the banners with minimal time and effort. Prior signage systems were difficult to assemble in the field and, once assembled, were difficult to break down for storage or reassembly in a different location. Finally, completely different signage systems were required for banners of different dimensions.

Generally, signage systems have a flexible banner supported by a rigid banner frame. Many signage systems include a banner that has eyeholes on the sides or corners, which thereby enable a hook, tensioning devices, or other attaching device to be attached to the banner while also being attached to the frame. For example, the four-corners of a banner contain eyeholes that can be engaged with a hook or other appropriate attachment means. One disadvantage of this system is that the banner must be made with costly eyeholes. In addition, stress placed on the eyeholes can cause the banner to tear. Further, other signage systems wrap a portion of the edge of the banner around a portion of the frame and clamp the banner to the frame. For example, the top banner edge is secured to the upper portion of the frame by wrapping it around the top frame bar and clamping into position with a clamping device. The bottom banner edge and the banner side edge are also wrapped around the corresponding frame bars and clamped into position. One disadvantage of this system is that the frame is complex to work and costly to construct and repair. Furthermore, signage systems often have only one possible banner frame dimension, which requires the purchase of many banner frames to accommodate various sized banners.

Thus, a heretofore unaddressed need exists in the industry to address the aforementioned deficiencies and inadequacies associated with currently used signage systems.

### SUMMARY OF THE INVENTION

An embodiment of the present invention provides a banner and frame system. The banner and frame system includes a modular banner frame and a frame support system. The modular banner frame includes a frame and a frame support system. The frame includes a plurality of frame sections and a plurality of frame connectors. The frame support system includes a plurality of support structures. The self-attaching banner includes a banner and an interlocking system. The interlocking system secures the self-attaching banner to the modular banner frame. The interlocking system includes a plurality of first fastener points and a plurality of second fastener points. The first fastener points and the second fastener points are positioned parallel to one another along the banner edges such that by folding the edge of the banner at a folding axis allows the first fastener points to interact with the second fastener points securely engaging one another. The self-attaching banner is secured to the banner frame using the interlocking system.

Another embodiment of the present invention provides a method of using a banner and frame. The method includes providing a modular banner frame, a self-attaching banner, and an interlocking system. The interlocking system is part of the self-attaching banner. The method further includes securing the self-attaching banner to the modular banner frame using the interlocking system, as described above.

Another embodiment of the present invention provides a self-attaching banner. The self-attaching banner includes a banner and an interlocking system. The interlocking system is similar to the interlocking system described above.

Still another embodiment of the present invention provides a method of using a self-attaching banner. The method includes providing a self-attaching banner and providing an interlocking system. The method further includes securing the interlocking system to a structure. The interlocking system operates like the interlocking system described above.

A further embodiment of the present invention provides a modular banner frame. The modular banner frame includes a frame and a frame support system. The frame includes a plurality of frame sections and a plurality of frame connectors. The frame support system includes a plurality of support structures.

Still a further embodiment provides a method of using a modular banner frame. The method includes providing a plurality of frame sections, providing a plurality of frame connectors that are capable of connecting to the frame sections, providing a plurality of frame support structures that are capable of connecting to the frame connectors, connecting the frame sections and frame connectors such that a banner frame is made, and connecting the frame support structures to the banner frame.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIGS. 1A-1D illustrate a front view of various configurations of an embodiment of the modular banner frame.

FIGS. 1E and 1F illustrate a side view of various configurations of an embodiment of the modular banner frame.

FIGS. 2 illustrates a rear view of a preferred embodiment of a self-attaching banner.

FIG. 3A-3C illustrate two back views and one front view of a preferred embodiment of the modular banner frame of FIG. 1A-1F that incorporate the self-attaching banner illustrated in FIG. 2.

FIG. 4 illustrates a cut out front view of one preferred embodiment of a modular banner frame and self-attaching banner system as shown in FIGS. 1A-1F, 2, and 3A-3C.

FIG. 5 illustrates a cut out front view of another preferred embodiment of a modular banner frame and self-attaching banner system as shown in FIGS. 1A-1F, 2, 3A-3C, and 4.

FIG. 6 illustrates a cut out side view of a preferred embodiment of a modular banner frame and self-attaching banner system as shown in FIGS. 1A-1F, 2, 3A-3C, 4, and 5.

FIG. 7A, 7B, and 7C illustrate cut out rear views of preferred embodiments of the present invention as shown in FIGS. 1A-1F, 2, 3A-3C, 4, 5, and 6.

### DETAILED DESCRIPTION OF THE INVENTION

Embodiments of the present invention will now be described in detail with reference to the drawings. Although the invention will be described in connection with these drawings, there is no intent to limit it to the embodiment or embodiments disclosed therein. On the contrary, the intent is to include all alternatives, modifications, and equivalents included within the spirit and scope of the invention as defined by the appended claims.

An embodiment of the present invention provides a self-attaching banner and modular banner frame system that includes a self-attaching banner that is placed upon a freestanding modular banner frame. A preferred embodiment of the present invention is a freestanding modular banner frame, hereinafter banner frame. The materials that the banner frame can be constructed of include, but are not limited to, PVC, plastic, wood, metal, or other suitable material as the frame. The banner frame can be of various shapes including, but not limited to, a square, a rectangle, a circle, and various other shapes. In addition, the banner frame is free standing and has footings or feet to hold the banner frame upright.

Another embodiment of the present invention is a self-attaching banner that is self-attaching around the banner frame by use of an interlocking system. The interlocking system includes, but is not limited to, snaps, zippers, buttons, Velcro, hooks and loops, suctions cups, snap tape, tape, adhesives, and other appropriate attaching means. Generally, the interlocking system is located on the perimeter of the banner, but could be located at other points as needed. An additional embodiment includes a banner that has one or more eyelets along the edges of the banner. In this embodiment the banner and banner frame may be hung from or on a wall, fence, or ceiling.

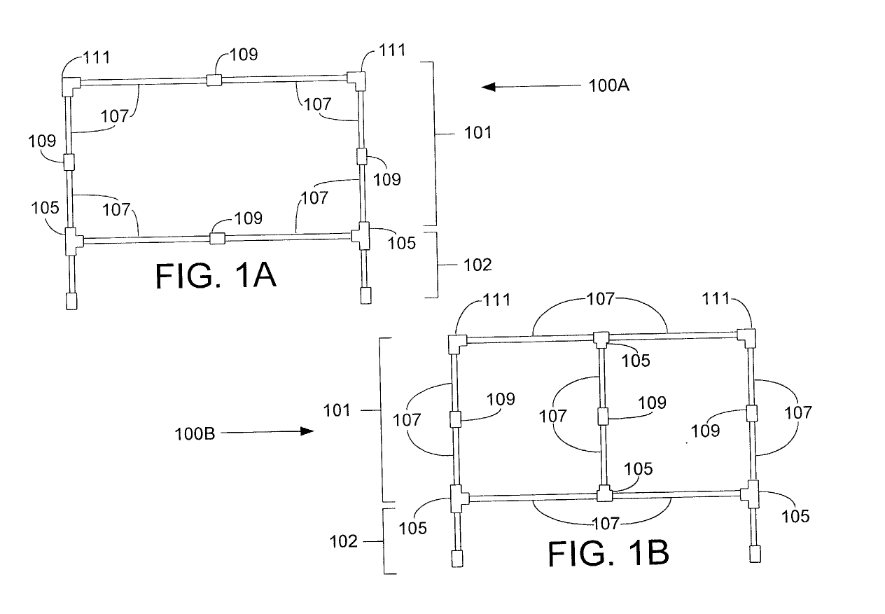

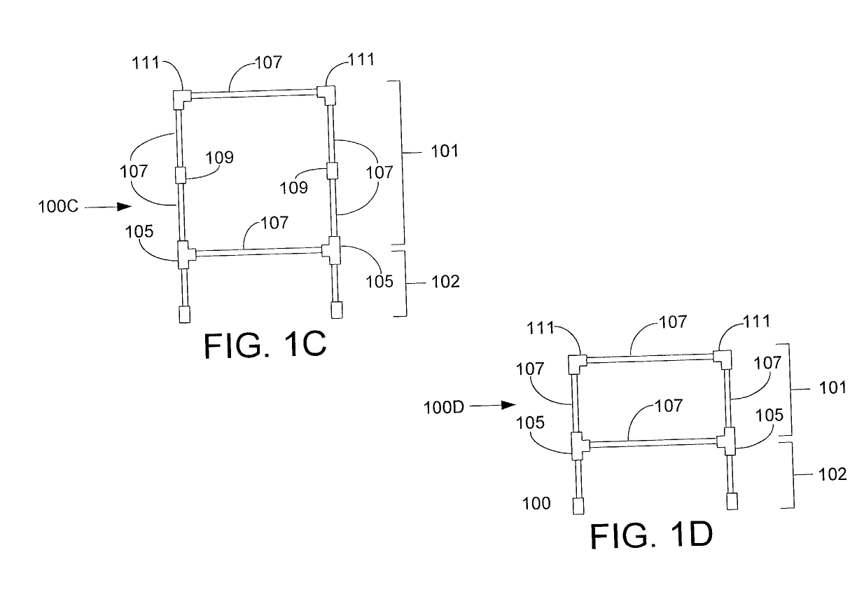

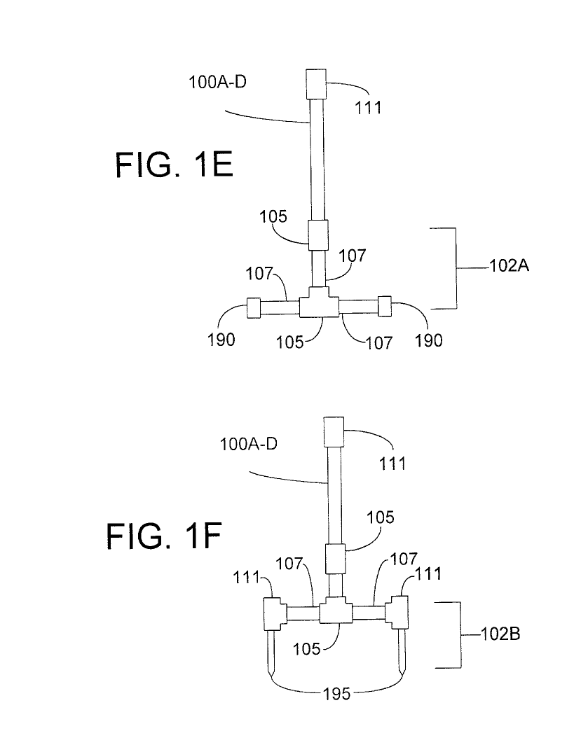

FIGS. 1A-1D illustrate a front view of numerous configurations that illustrate the flexibility of an embodiment of the present invention. The banner frame 100A-D configurations of an embodiment illustrated in FIGS. 1A-1D includes a frame 101 and a frame support system 102A-B. The modular banner frame 100A-D can be easily and quickly constructed in numerous sizes and shapes. Further, additional banner frame kits or parts can be inexpensively purchased if parts are lost or broken, rather than purchasing an entire banner frame. These configurations are herein discussed in further detail with regard to FIGS. 1A-1D.

FIG. 1A illustrates one of the banner frame 100A configurations of an embodiment of the present invention. The frame 101 is made of a plurality of frame components, which include frame sections 107 and frame connectors 105, 109, and 111. The frame sections 107 can be of one or more lengths. In addition, the frame sections 107 can be curved (not shown) so that circular banner frames can be constructed. The frame connectors 105, 109, and 111 accept the frame sections 107 in one or more frame connector acceptors. Non-limiting illustrative examples of frame connectors include the T-connector 105, straight connectors 109, corner connectors 111, and cross connectors (not shown). In addition, the connectors can be curved (not shown) so that circular banner frames can be constructed. The frame sections 107 are of an appropriate length for the type of banner frame that is needed. A non-limiting illustrative example is a banner frame that would be used in the front of a gas station or other similar establishment that would have frame sections 107 that are one foot and two feet in length. This would allow banner frames of various sizes to be easily constructed and modified for various banner sizes. However, the preferred embodiment would include two or fewer frame sections 107 of particular lengths, e.g., one and two foot sections.

The frame support system 102 also illustrated in FIG. 1A is constructed of two frame support structures, which are located at either end of the banner frame 100A. However, more frame support structures can be added to the frame support system 102 if additional support is needed. The embodiment illustrated in FIG. 1A includes a frame support system 102 that is illustrated in more detail in FIGS. 1E and 1F.

Each frame support structure is connected to a T-connector 105 that also connects to two frame sections 107 in the vertical and horizontal directions. A straight connector 109 connects two frame sections 107 in the horizontal direction. The vertical frame sections 107 are connected to other frame sections 107 via straight connectors 109. The vertical frame sections 107 are connected to corner connectors 111 at the top of the banner frame 100A. The two corner connectors 111 connect two frame sections 107. The two frame sections 107 at the top of the banner frame 100A are connected using another straight connector 109.

The banner frame 100B configuration shown in FIG. 1B is modified from the banner frame 100A configuration shown in FIG. 1A. The modification of banner frame 100A configuration to form banner frame 100B configuration is the addition of a pair of frame sections 107 and frame connectors 105 and 109 between the banner frame support structures. This configuration would provide more support in the middle of the banner frame 100B for longer or heavier banners. Other embodiments, not shown, would include banner frames that have multiple frame support structures 102, e.g., interval and edge support structures.

The banner frame 100C configuration illustrated in FIG. 1C is also a modification of the banner frame 100A-B configurations shown in FIGS. 1A and 1B, respectively. FIG. 1C illustrates a smaller banner frame 100C configuration, which demonstrates the versatility of an embodiment of the present invention. Similarly, the banner frame 100D configuration illustrated in FIG. 1D also illustrates another banner frame 100D configuration size that can be constructed using the present invention.

The banner frame support system 102 includes a plurality of frame support structures. FIGS. 1E and 1F illustrate configurations of the frame support structures 102A-B. Banner frames 100A-D can be supported using either frame support structure 102A-B.

FIG. 1E illustrates a frame support structure with feet 102A. The frame support structure 102A is constructed using the same banner frame sections 107 and banner connectors 105, 109, and 111 that the banner frames 100A-D are constructed of with the addition of the foot end 190. The frame support structure 102A uses frame sections 107 that are perpendicular (horizontal foot section) to the banner frame 100A-D to preclude the banner frame 100A-D from flipping over or being pushed over due to inclement weather conditions. In addition, multiple frame sections 107 can be connected with straight connectors 109 to lengthen the horizontal foot section for added support. FIGS. 1A-1D show only a pair of frame support structures 102A, however the present invention is not limited to only a pair of frame support structures. Three or more frame support structures may be needed to support longer banner frames.

FIG. 1F illustrates an alternative configuration of the frame support structure 102B that can also be used in the banner frames 100A-D illustrated in FIGS. 1A-1D. Like the frame support structure 102A described in FIG. 1E, the frame support structure 102B uses many of the same components that are used to construct the banner frame 100A-D. An additional component of the frame support structure 102B illustrated in FIG. 1F is the frame spike 195. The banner frame 100A-D is supported using the frame support structure 102B by driving the frame spikes 195 into the ground. FIGS. 1A-1D illustrate only a pair of frame support structures 102B, but three or more frame support structures 102B can be used for additional support. The frame spikes 195 can be of various lengths for added support.

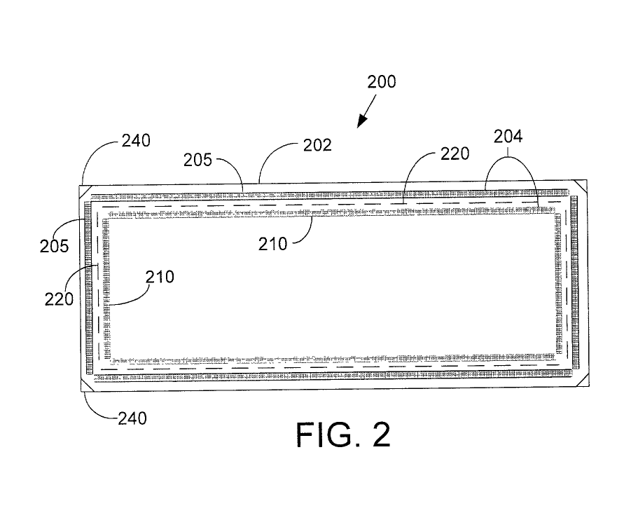

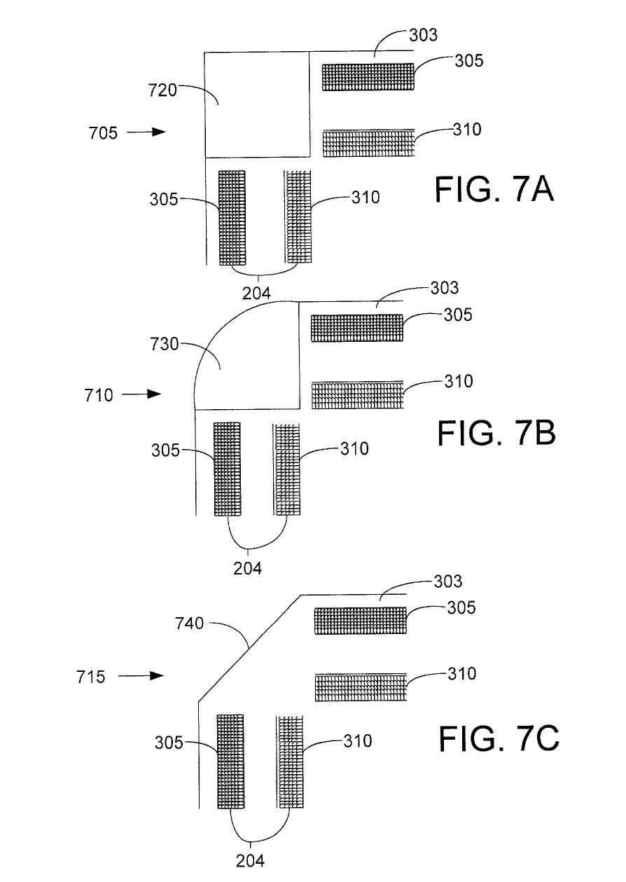

FIG. 2 illustrates a self-attaching banner system 200. The banner system 200 includes a banner 202 with an interlocking system 204. The interlocking system 204 includes a plurality of first fastener points 205 and a plurality of second fastener points 210. The interlocking system 204 is herein defined in further detail with regard to FIGS. 4-7. The interlocking system 204 includes, but is not limited to, the following system: snaps, zippers, buttons, velcro, hooks and loops, suctions cups, snap tape, tape, adhesives, and other appropriate attaching systems. The interlocking system 204 is located at the edges of the banner, e.g., the top, bottom, sides or any combinations thereof. The interlocking system 204 can span the entire peripheral of the banner 200 or only select portions of the banner 200. A non-limiting illustrative example is an interlocking system 204 that does not extend to the corners. The interlocking system 204 has at least two fastener points 205 and 210. The fastener points 205 and 210 are appropriately spaced from one another to allow the wrapping of the banner 200 about a folding axis 220 around a banner frame section 107. A non-limiting illustrative example is fastener points constructed of Velcro that have little or no space between the first fastener 205 and second fastener 210 because the first fastener Velcro point 205 can attach at any point on the second fastener Velcro point 210. However, snaps need to be appropriately spaced so that the banner can be wrapped around the banner frame section 107. But this can be overcome by having multiple rows of first fastener snap points 205 and second fastener snap points 210. In addition, multiple rows of first fastener points 205 and second fastener points 210 can be made for zippers, buttons, suctions cups, snap tape, tape, adhesives, and other appropriate attaching systems. Further, the corners can be reinforced, elastic, or angled 240, as shown in FIGS. 7A, 7B, and 7C, respectively.

In another embodiment, the banner system 200 includes a banner 202 and a plurality of hems. The frame sections 107 can be inserted into the hems. The hems would be of appropriate size so that the frame section 107 and straight connectors 109 can slide through. This is unlike other banners that contain hems for a string, rope, rod, or wire. In a preferred embodiment, the banner 200 would have a hem on each side of the banner 202 (e.g., four hems) to support the banner 202 and prevent the banner 202 from blowing in the wind. This is unlike other banners that contain only one or two hems. In addition, the hems could be used in conjunction with the interlocking system 204, discussed above, on one or more sides of the banner 202.

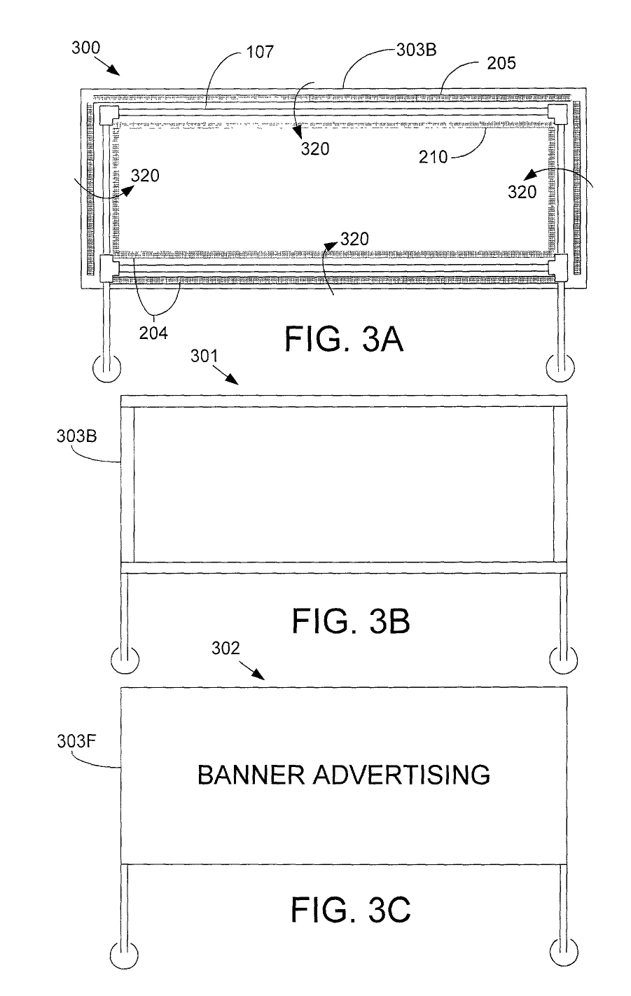

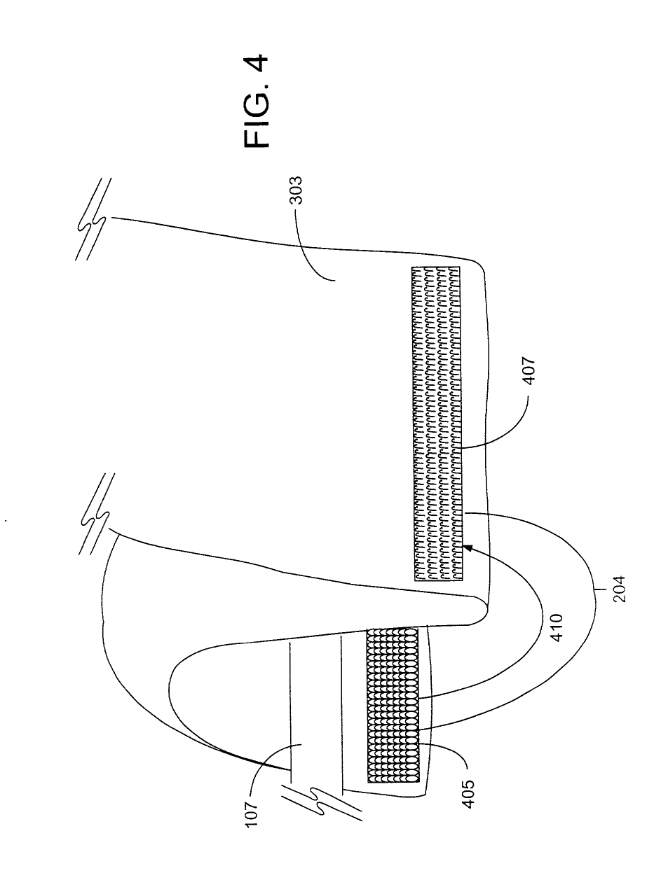

FIGS. 3A, 3B and 3C illustrate a preferred embodiment of the present invention that incorporates the embodiment shown in FIGS. 1A-1F and 2. FIG. 3A illustrates a rear view of the banner frame 100 and the self-attaching banner 303B, banner and frame system 300. The self-attaching banner 303B includes a banner 303B and an interlocking system 204. The interlocking system 204 includes a plurality of first fastener points 205 and a plurality of second fastener points 210. In order for the banner 303B to be attached to the banner frame 100 the first fastener point 205 is wrapped 320 around the banner frame section 107 until the first fastener point interlocks with the second fastener point 210.

FIG. 3B illustrates a rear view of the banner and frame system 301 after the first fastener points 205 are interlocked with the second fastener points 210. FIG. 3C is a front view of the banner system 302 after the first fastener points 205 of the banner 303F are wrapped 320 around the banner frame 100 and interconnected to the second fastener points 210.

FIG. 4 is an exploded view of a particular interlocking system 204 that illustrates a cut out of the interlocking of the first fastener point 205 and the second fastener point 210. However, FIG. 4 illustrates the use of a specific interlocking system 204, the Velcro system or hook and loop system. The interlocking system 204 illustrated in FIG. 4 operates by wrapping 410 the banner 303 around the frame section 107. More specifically, the first fastener points 405 are wrapped around the frame section 107 and interconnected to the second fastener points 407 to securely attach the banner 303 to the banner frame 100A-D. The same process is repeated for each side of the banner 303 that is to be attached to the banner frame 100A-D. The hook and loop system includes hooks as the first fastener points and loops as the second fastener points or vice versa. The hooks engage the loops and form a secure attachment. The hook and loop system is very similar to the well-known Velcro system.

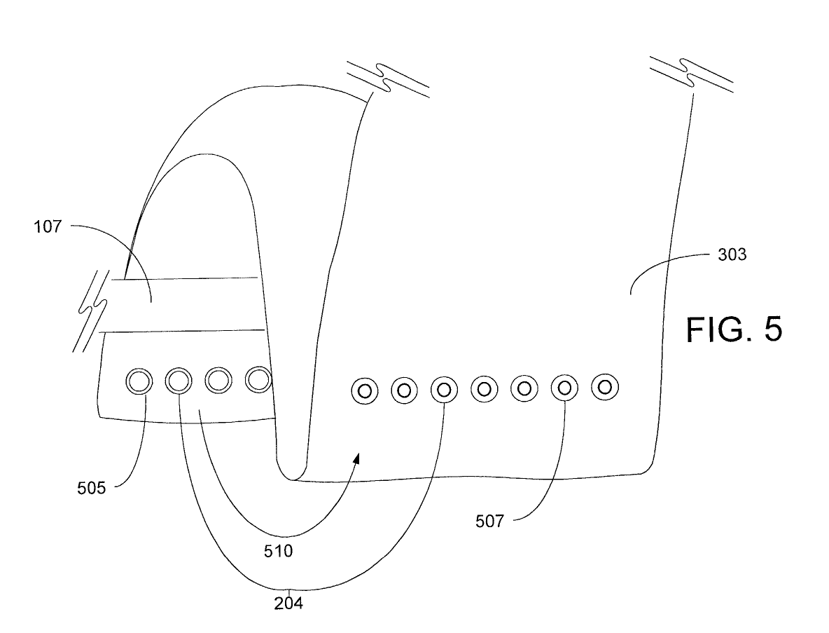

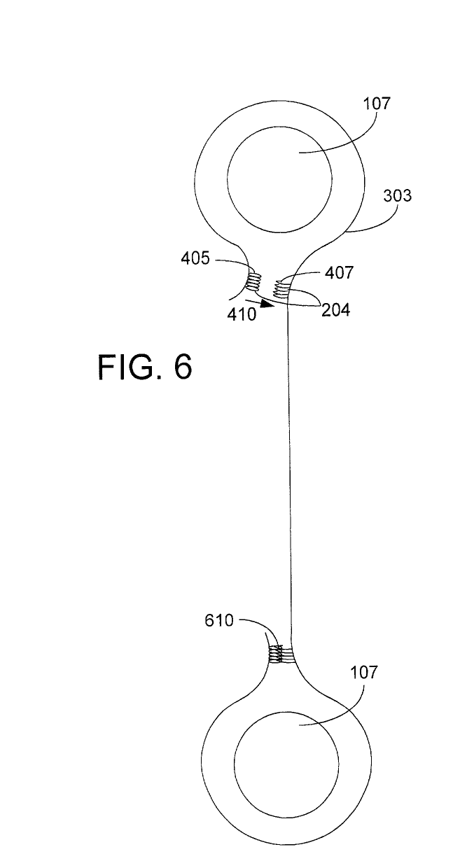

FIG. 5 is an exploded view of a particular interlocking system 204 that illustrates an alternative interlocking system 204 that can be used with the banner and frame system. The interlocking system 204 illustrated in FIG. 5 is a snap system. The snap system operates by wrapping 510 the banner 303 around the frame section 107 and interconnecting the snaps 505 and snap receptacles 507. The snaps 505 and snap receptacles 507 correspond to the first fastener point 505 and the second fastener point 507, respectively. Also, the position of the snap and snap receptacle can be switched so that the first fastener point is the snap receptacle and the second fastener point is the snap. FIG. 6 is an exploded view of a particular interlocking system 204 that illustrates a side view of a cut out portion of the banner frame 100A-D and banner 303, banner and frame system 300B and 300F. The top portion of FIG. 6 illustrates the banner 303 where the first fastener point 405 and a second fastener point 407 have not yet been interconnected. The first fastener point 405 can be connected to the second fastener point 410 by moving the first fastener point 405 towards the second fastener point 407 until the two are interconnected. The bottom portion of FIG. 6 illustrates the interconnection 610 of the first fastener point 405 and the second fastener point 407 as describe by 410.

FIGS. 7A, 7B, and 7C illustrate possible corner configurations of the present invention. FIG. 7A illustrates a corner configuration 705 that includes a reinforcing material 720 at the corner to prevent the banner 303 from tearing. The reinforcing material 720 can be made of any material that could prevent tearing and can be of any size or shape that prevents tearing including, but not limited to, cloth, plastic, metal, or any other tear resistant material.

FIG. 7B illustrates an alternative embodiment of the corner configuration 710. The corner illustrated in FIG. 7B includes an elastic material 730 placed in the corner position. The elastic material 730 can be made of any material that is elastic and can support the strain imposed by the banner 303 including, but not limited to, plastic, cloth, or other elastic material.

FIG. 7C illustrates an alternative embodiment of the corner configuration 715. The corner illustrated in FIG. 7C cuts off one or more of the pointed portions of the corners 740, which enables the banner 303 to engage a banner frame without an overlapping corner section. A banner 303 that has cut-off corners is called a cut-off corner banner. The corners can be cut off to varying degrees as needed per application use. The reinforcing or elastic material, discussed and listed above, can be used as additional support with this embodiment along the remaining corner area.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A banner and frame system comprising:
a modular banner frame, wherein said modular banner frame further comprises a frame and a frame support system, wherein said frame includes a plurality of frame sections and a plurality of frame connectors and wherein said frame support system includes a plurality of support structures; and
a self-attaching banner, wherein said self attaching banner further comprises a banner and an interlocking system, wherein said interlocking system secures said self-attaching banner to said modular banner frame, said interlocking system includes a plurality of first fastener points and a plurality of second fastener points, wherein said first fastener points and said second fastener points are positioned parallel to one another along the banner edges such that by folding the edge of said banner at a folding axis allows said first fastener points to interact with said second fastener points securely engaging one another and wherein said self-attaching banner is secured to said modular banner frame using said interlocking system.

2. The banner and frame system of claim 1, wherein said interlocking system comprises a hook and loop system.

3. The banner and frame system of claim 1, wherein said interlocking system comprises a snap system.

4. A method of using a banner and frame system comprising:
providing a modular banner frame; wherein said modular banner frame further comprises a frame and a frame support system, wherein said frame includes a plurality of frame sections and a plurality of frame connectors and wherein said frame support system includes a plurality of support structures;
providing a self-attaching banner,
providing an interlocking system, wherein said interlocking system is part of said self-attaching banner;
securing said self-attaching banner to said modular banner frame using said interlocking system, wherein said interlocking system includes a plurality of first fastener points and a plurality of second fastener points, wherein said first fastener points and said second fastener points are positioned parallel to one another along the banner edges such that by folding the edge of said self attaching banner at a folding axis allows said first fastener points to interact with said second fastener points forming a secure attachment therebetween.

5. The method of claim 4, wherein said step of providing an interlocking locking system further includes providing an interlocking system that uses a hook and loop system.

6. The method of claim 4, wherein said step of providing an interlocking locking system further includes providing an interlocking system that uses a snap system.

7. A banner and frame system comprising:
a means for providing a modular banner frame; wherein said modular banner frame further comprises a frame and a frame support system, wherein said frame includes a plurality of frame sections and a plurality of frame connectors and wherein said frame support system includes a plurality of support structures;
a means for providing a self-attaching banner;
a means for providing an interlocking system, wherein said interlocking system is part of the self-attaching banner;
a means for securing said self-attaching banner to said modular banner frame using said interlocking system, wherein said interlocking system includes a plurality of first fastener points and a plurality of second fastener points, wherein said first fastener points and said second fastener points are positioned parallel to one another along the banner edges such that by folding the edge of said self attaching banner at a folding axis allows said first fastener points to interact with said second fastener points forming a secure attachment therebetween.

8. The system of claim 7, wherein said step of providing an interlocking locking system further includes a means for providing an interlocking system that uses a hook and loop system.

9. The system of claim 7, wherein said step of providing an interlocking locking system further includes a means for providing an interlocking system that uses a snap system.

10. A self-attaching banner comprising a banner and an interlocking system, wherein said interlocking system includes a plurality of first fastener points and a plurality of second fastener points, wherein said first fastener points and said second fastener points are positioned parallel to one another along the banner edges such that by folding the edge of said banner at a folding axis allows said first fastener points to interact with said second fastener points forming a secure attachment therebetween.

11. The self-attaching banner of claim 10, wherein said interlocking system comprises a hook and loop system.

12. The self-attaching banner of claim 10, wherein said interlocking system comprises a snap system.

13. The self-attaching banner of claim 10, wherein said banner includes reinforced corners.

14. The self-attaching banner of claim 10, wherein said banner includes elastic corners.

15. The self-attaching banner of claim 10, wherein said banner is a cut-off corner banner.

16. A method of using a self attaching banner comprising providing a self-attaching banner;
providing a interlocking system, wherein said interlocking system is part of the self-attaching banner;
securing said interlocking system to a structure, wherein said interlocking system includes a plurality of first fastener points and a plurality of second fastener points, wherein said first fastener points and said second fastener points are positioned parallel to one another along the banner edges such that by folding the edge of said self attaching banner at a folding axis allows said first fastener points to interact with said second fastener points forming a secure attachment therebetween.

17. The method of claim 16, wherein said step of providing an interlocking locking system further includes providing an interlocking system that uses a hook and loop system.

18. The method of claim 16, wherein said step of providing an interlocking locking system further includes providing an interlocking system that uses a snap system.

19. A self-attaching banner system comprising
a means for providing a self-attaching banner;
a means for providing a interlocking system, wherein said interlocking system is part of the self-attaching banner;
a means for securing said interlocking system to a structure, wherein said interlocking system includes a plurality of first fastener points and a plurality of second fastener points, wherein said first fastener points and said second fastener points are positioned parallel to one another along the banner edges such that by folding the edge of said self attaching banner at a folding axis allows said first fastener points to interact with said second fastener points forming a secure attachment therebetween.

20. The system of claim 19, wherein said step of providing an interlocking locking system further includes a means for providing an interlocking system that uses a hook and loop system.

21. The system of claim 19, wherein said step of providing an interlocking locking system further includes a means for providing an interlocking system that uses a snap system.

22. A banner frame comprising a modular banner frame, wherein said modular banner frame further comprises a frame and a frame support system, wherein said frame further comprises a plurality of frame sections and a plurality of frame connectors and wherein said frame support system further comprises a plurality of support structures.

23. A method of using a modular banner frame comprising:
providing a plurality of frame sections;
providing a plurality of frame connectors that are capable of connecting to said frame sections;
providing a plurality of frame support structures that are capable of connecting to said frame connectors;
connecting said frame sections and frame connectors such that a banner frame is made; and
connecting said frame support structures to said banner frame.

24. A modular banner frame system comprising
a means for providing a plurality of frame sections;
a means for providing a plurality of frame connectors that are capable of connecting to said frame sections;
a means for providing a plurality of frame support structures that are capable of connecting to said frame connectors;
a means for connecting said frame sections and frame connectors such that a banner frame is made; and
a means for connecting said frame support structures to said banner frame.

25. A self-attaching banner comprising a banner including four hems.
